(19) United States
(12) Patent Application Publication
(10) Pub. No.: US 2019/0279330 A1
(43) Pub. Date: Sep. 12, 2019

(54) WATERMARK EMBEDDING METHOD AND APPARATUS

(71) Applicant: MARKANY INC., Seoul (KR)

(72) Inventors: So Won KIM, Seoul (KR); Ji Seop MOON, Seoul (KR); Gyeong Gi NOH, Seoul (KR); Euee Seon JANG, Seoul (KR)

(21) Appl. No.: 15/917,841

(22) Filed: Mar. 12, 2018

(51) Int. Cl. G06T 1/00

(52) U.S. Cl. CPC G06T 1/0021; G06T 2201/0053; G06T 2201/0051

(57) ABSTRACT

One aspect of the present invention discloses a watermark embedding method in a watermark embedding apparatus. The method includes inputting a video frame, generating at least two tiles by spatially dividing the video frame, and embedding watermark information to each of the at least two tiles.

### BACKGROUND OF THE INVENTION

### Field of the Invention

The present invention relates to a watermark embedding method and, more particularly, to a method for efficiently embedding a watermark into a video stream within a short time.

### Related Art

The conventional server-based watermark embedder inserts a watermark in units of segments. In the conventional server-based watermark embedder, 1 bit of a watermark corresponds to the length of a segment, which elongates the time for extracting a watermark. For example, when a segment lasts 4 seconds, and at least 40 bits are employed without involving an error correcting code (ECC), data has to be inserted for over at least 160 seconds. Thus the time required for embedding and detecting a watermark is elongated, causing a large burden on both the encoder and the decoder.

### SUMMARY OF THE INVENTION

To solve the technical problem above, an object of the present invention according to one aspect is to provide a method and an apparatus for performing encoding and embedding a watermark which generate a predetermined number of tiles sharing no data with each other to increase an amount of embedded watermarks.

To achieve the object above, a watermark embedding method in a watermark embedding apparatus according to one aspect of the present invention may include inputting a video frame; generating at least two tiles by spatially dividing the video frame; and embedding watermark information to each of the at least two tiles.

The embedding watermark information to each of at least two tiles may include embedding different watermark information to each of the at least two tiles.

Each of the at least two files may be encoded independently and may not form a reference relationship with the other tile.

The inputting a video frame may include inputting a plurality of video frames continuously in time, at least part of the plurality of input video frames is divided into at least two tiles, and each tile divided from a video frame may belong to one of a first and a second tile group.

A tile belonging to the first tile group in a first video frame may be encoded to form a reference relationship with tiles belonging to the first tile group before or after the first video frame but not to form a reference relationship with tiles belonging to the second tile group.

A video stream associated with tiles belonging to the first tile group and a video stream associated with tiles belonging to the second tile group may be processed in parallel by using different processors.

When the video frame is a pre-encoded video stream, the watermark embedding method may include decoding the pre-encoding video stream, extracting a portion having a reference relationship with other tile groups from the decoded video stream, removing a reference relationship of the extracted portion, and re-encoding the extracted portion in a tile-independent manner by removing a reference relationship with tiles of the other tile group.

A scene cut frame which does not reference a previous video frame may not be divided into tiles but may be referenced commonly by different tiles of a video frame referencing the scene cut frame.

When the video frame is a B frame, watermark information composed of a smaller number of bits than a reference value may be embedded while, when the video frame is an I frame, watermark information composed of a larger number of bits than a reference value may be embedded.

When the amount of information of the video frame is less than a first reference value, watermark information composed of a smaller number of bits than a second reference value is embedded while, when the amount of information of the video frame is larger than the first reference value, watermark information composed of a larger number of bits than the second reference value may be embedded.

The at least two tiles may be associated with the HEVC (High Efficiency Video Coding) standard.

In dividing the at least two tiles, the watermark embedding method may further include determining a tile size and a tile structure by estimating at least one of complexity and decoding time for each tile.

In dividing the at least two tiles, tile division may be performed in a direction of allocating an equal amount of task for processors corresponding to the respective tiles by taking into account at least one of complexity and decoding time for each tile.

To achieve the object above, a watermark embedding apparatus according to one aspect of the present invention may include an input unit inputting a video frame and a controller generating at least two tiles by spatially dividing the video frame and embedding watermark information to each of the at least two tiles.

The controller includes at least two processors, and each of the at least two tiles may be processed in parallel by the corresponding one of the at least two processors.

According to a watermark embedding method and an apparatus of the present invention, particularly, the amount of embedded server-based watermarks may be increased several times.

### BRIEF DESCRIPTION OF THE DRAWINGS

FIG. 1 illustrates tiles divided from one video frame by a watermark embedding method according to one embodiment of the present invention.

FIG. 2 illustrates a tile-based encoding method which uses multi-cores in a watermark embedding method according to one embodiment of the present invention.

FIG. 3 illustrates watermark information embedded to each tile by using a watermark embedding method according to one embodiment of the present invention.

FIG. 4 is a flow diagram illustrating a watermark embedding method according to one embodiment of the present invention.

FIG. 5 illustrates an encoding concept in which video frames input continuously over time are divided into a plurality of tile groups and encoded separately.

FIG. 6 illustrates a method for performing encoding of one reference frame and subframes according to another embodiment of the present invention.

FIG. 7 is a flow diagram illustrating a watermark embedding method which embeds watermarks for video frames having different amounts of information according to one embodiment of the present invention.

FIG. 8 illustrates a watermark embedding apparatus according to one embodiment of the present invention.

### DESCRIPTION OF EXEMPLARY EMBODIMENTS

The present invention may be modified in various ways and may have various embodiments, where specific embodiments will be described in detail with reference to appended drawings.

However, it should be understood that the appended drawings are not intended to limit the present invention to specific embodiments but include all of modifications, equivalents or substitutes described by the technical principles and belonging to the technical scope of the present invention.

The terms such as first and second may be used to describe various elements, but the elements may not be limited by the terms. The terms are introduced only to distinguish one element from the others. For example, without departing from the technical scope of the present invention, a first element may be called a second element, and similarly, the second element may be called the first element. The term of and/or includes a combination of a plurality of related described items or any of a plurality of related described items.

If an element is said to be “linked” or “connected” to other element, the former may be linked or connected to the other element directly, but it should be understood that another element may be present between the two elements. On the other hand, if an element is said to be “directly linked” or “directly connected” to other element, it should be understood that there is no other element present between the two elements.

The terms used in the present invention have been introduced only to describe specific embodiments and are not intended to limit the technical scope of the present invention. A singular expression should be understood to indicate a plural expression unless otherwise explicitly stated. The term of “include” or “have” is used to indicate existence of an embodied feature, number, step, operation, element, component, or a combination thereof; and should not be understood to preclude the existence or possibility of adding one or more other features, numbers, steps, operations, elements, components, or a combination thereof.

Unless defined otherwise, all of the terms used in this document, including technical or scientific ones, provide the same meaning as understood generally by those skilled in the art to which the present invention belongs. Those terms defined in ordinary dictionaries should be interpreted to have the same meaning as conveyed by a related technology in the context. And unless otherwise defined explicitly in the present invention, those terms should not be interpreted to have ideal or excessively formal meaning.

In what follows, preferred embodiments of the present invention will be described in detail with reference to appended drawings. In describing the present invention, to facilitate the overall understanding, the same reference symbols are used for the same elements of the appended drawings, and repeated descriptions of the same elements will be omitted.

Throughout the document, a watermark embedding apparatus may be called an encoder, transcoder, and/or watermark embedder. Also, a watermark embedding apparatus may be implemented by various types of devices such as a personal computer (PC); notebook computer; personal digital assistant (PDA); portable multimedia player (PMP); playstation portable (PSP); wireless communication terminal; smartphone; server terminal including a TV application server and a service server; user terminal; or other device including a communication device such as communication modem for performing communication with a wired or wireless communication network, memory for storing various programs and data for encoding or decoding a video frame or for inter- or intra-prediction for encoding or decoding, and microprocessor for executing programs and performing calculations and control.

Also, a video encoded into a bit stream by a watermark embedding apparatus is transmitted in real-time or non-real time to a watermark detection apparatus (or video decoding apparatus) through a wired or wireless communication network such as the Internet, short range wireless communication network, wireless LAN, Wibro network, or mobile communication network or through various communication interfaces such as a cable and universal serial bus (USB); the original video is recovered and played as the transmitted bit stream is decoded.

In general, a video may be constructed by a series of pictures or frames, where each frame may be divided into predetermined regions such as units or blocks. When a video frame is divided into blocks, the divided blocks may be classified into intra-blocks and inter-blocks according to an employed encoding method. An intra-block refers to a block encoded by using an intra-prediction coding method, where intra-prediction encoding refers to a method which predicts pixels of a current block within a current picture for which encoding is being performed by using the pixels of restored blocks from encoding and decoding in a previous frame, generates a predicted block, and encodes disparities from the pixels of the current block. An inter-block refers to a block encoded by using inter-prediction coding, where inter-prediction encoding refers to a method which predicts a current block within a current picture by referencing one or more previous or future pictures, generates a predicted block, and encodes disparities from the current block. At this time, the frame referenced for encoding or decoding a current picture is called a reference frame. Also, it should be understood by those skilled in the art to which the present invention belongs that the term of “picture” used in the following descriptions may be substituted for by other terms having an equivalent meaning such as an image or a frame. Also, it should be understood by those skilled in the art to which the present invention belongs that a picture referenced in the present invention refers to a restored picture. Also, data related to a picture, image and/or frame may be called a video stream and/or a bit stream.

Furthermore, the term of block may be a concept including a coding tree unit (CTU), coding unit (CU), prediction unit (PU), and transform unit (TU) of the HEVC standard. For example, when a CTU is 64×64, the CTU may be divided into four 32×32 blocks for encoding, where each 32×32 block may correspond to a CU.

Also, tiles are a new feature of the HEVC standard, introduced to support encoding and decoding. Tiles represent regions divided from a frame in units of CTUs. In other words, tiles refer to regions which may be encoded or decoded simultaneously. When tiles are used, bits generated separately from divided regions are expressed by sub-bit streams, and the start position of each sub-bit stream is transmitted through a slice header. Therefore, when tiles are employed, entropy decoding part may also be processed in parallel.

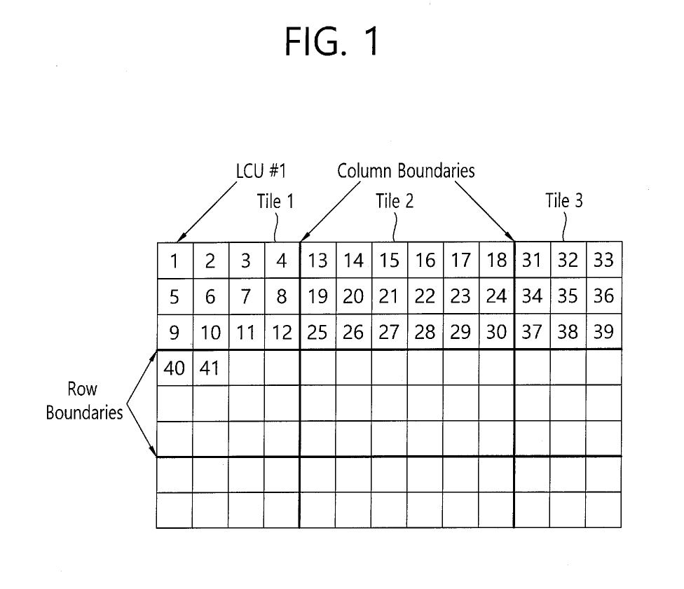

FIG. 1 illustrates tiles divided from one video frame by a watermark embedding method according to one embodiment of the present invention.

Referring to FIG. 1, a video frame is spatially divided into tiles. Conventionally, tiles may be regarded as a set of rectangular LCUs (Largest Coding Units). Tiles may be a feature introduced in the next-generation codec standard such as the HEVC (High Efficiency Video Coding) to improve encoding/decoding efficiency through multi-core based parallel programming.

Tile is a spatial unit defined by column boundaries and row boundaries. A tile may change the order of performing LCUs to the raster order within the tile. Therefore, in a memory-constrained environment, a wider range of motion search may be allowed than a slice-based frame division under the same conditions. However, it should be clearly understood by those skilled in the art that a parallel processing-based watermark embedding method of the present invention may also be applied to slice-based encoding.

Tiles may be set as independent and dependent tiles. Since an independent tile performs an encoding task such as encoding prediction and entropy coding independently in units of tiles as in a slice, it may be suitable for multi-core based parallelism by dividing video frames. However, since both the encoding prediction and entropy coding may be performed across tile boundaries in the case of dependent tiles, reduction in compression performance is small, but parallel processing of dependent tiles is difficult to implement.

According to an embodiment of the present invention, it is preferable for a watermark embedding apparatus to use independent tiles. Independent tiles may be processed in parallel, and encoding may be performed independently within a single tile. At this time, complete parallel processing may be made possible by not allowing a reference relationship with other tiles.

And a watermark embedding apparatus according to an embodiment of the present invention may embed watermark information to each tile within one video frame. At this time, the embedded watermark information may be composed of at least one bit or more. If one video frame is divided into four tiles, and watermark information of 1 bit is embedded into each tile, four bits of watermark information may be embedded into one video frame.

The watermark embedding apparatus may divide a video frame into tiles of an equal size or different sizes. At this time, by estimating complexity and/or decoding time for each tile, size and structure of each tile and the number of tiles may be determined. At this time, the watermark embedding apparatus may perform division of a video frame into tiles in a direction of allocating an equal amount of task to each core by taking into account determination criteria of the tile division.

According to an embodiment of the present invention, complexity of each tile is estimated, and based on the estimation, the number of tiles to be allocated to each core and tile structure may be controlled by taking into account load balance and coding efficiency. At this time, from the relationship between the amount of encoded bits of a CTU and decoding time, complexity and/or decoding time may be estimated.

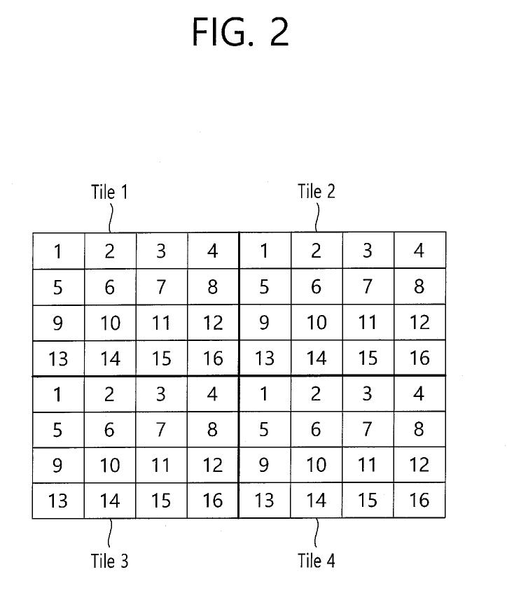

FIG. 2 illustrates a tile-based encoding method which uses multi-cores in a watermark embedding method according to one embodiment of the present invention.

Referring to FIG. 2, a watermark embedding apparatus may include a module which determines an encoding mode in units of LCUs and a module which actually performs encoding. The encoding mode determining module may determine the optimal size (the number of tiles and tile structure) and encoding mode in terms of complexity of a CU (Coding Unit), PU (Prediction Unit), and TU (Transform Unit). At this time, load balance and/or coding efficiency may be considered. The complexity of a coding unit (or coding tree unit) of a current video frame may be calculated from the complexity of the coding tree unit of a previous video frame.

According to an embodiment of the present invention, the watermark embedding apparatus may use a mode determining module in units of tiles to speed up efficient encoding and process tiles in parallel by allocating threads to cores.

As shown in FIG. 2, when tile-based encoding is performed by using multi-cores, it is preferable to perform encoding from the left uppermost unit of each tile. At this time, shared data required for tile-wise encoding (CABAC-related data structure and QP configuration structure) may be formed into an array, which is allocated to each tile.

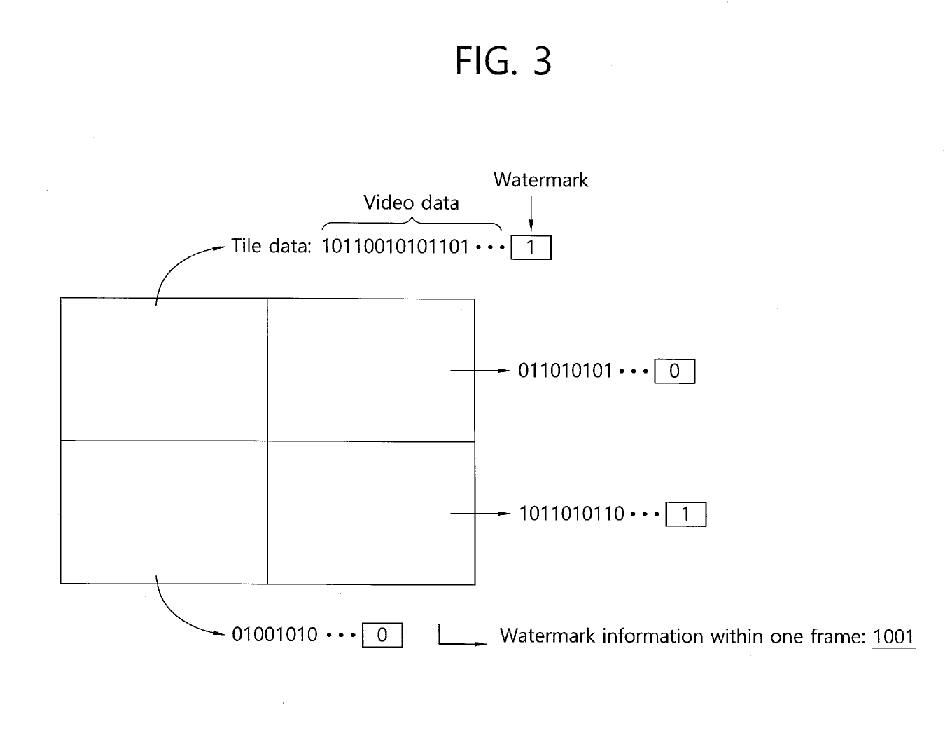

FIG. 3 illustrates watermark information inserted to each tile by using a watermark embedding method according to one embodiment of the present invention.

Referring to FIG. 3, one frame is spatially divided into a plurality of tiles. Each tile is processed by a different processor (or core). A watermark embedding apparatus may insert watermark information to the data encoded with respect to the corresponding tile. The insertion position may be determined by the user. For example, a watermark may be embedded at the very first of a tile or may be embedded at the very last part of the tile. Similarly, a watermark may be embedded into a different position from the very first or the very last position of a tile. In this way, if a watermark of a predetermined size is embedded for each tile unit, information of a large amount of bits may be inserted into one frame composed of at least two tiles. For example, when a watermark of one bit is inserted to each tile and four tiles are given, a watermark of four bits may be inserted for one frame. In other words, a watermark of “1” may be inserted into a first tile, “0” into a second tile, “0” into a third tile, and “1” into a fourth tile, after which a watermark of “1001” may be inserted by extracting the individual bits. In this way, if one frame is divided into tiles and watermarks composed of multiple bits are inserted, watermark information may be embedded in much more efficiently in a short time than the case where only one bit of watermark is embedded in units of segments.

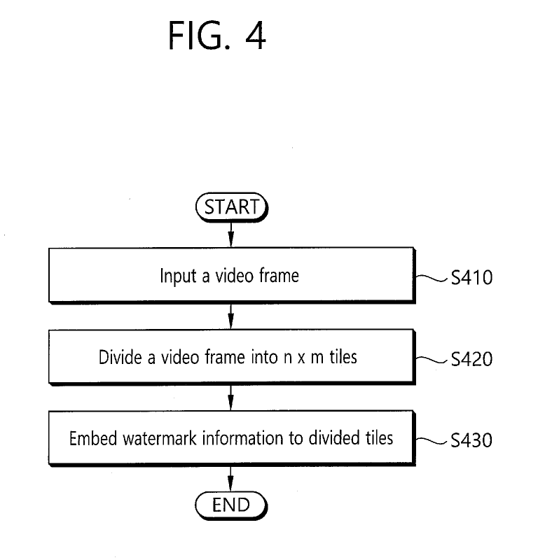

FIG. 4 is a flow diagram illustrating a watermark embedding method according to one embodiment of the present invention.

Referring to FIG. 4, a watermark embedding apparatus inputs a video frame S410. And the watermark embedding apparatus divides an input video frame into n×m tiles S420. Here, n and m represent an integer of 1 or more. And the watermark embedding apparatus provides the divided tiles to different cores, and each core performs encoding of the divided tiles. At this time, it is preferable to remove those tiles referencing or being referenced by other tiles and/or not independent from other tiles. Accordingly, encoding is performed independently for each tile. After encoding is completed for each tile, watermark information is embedded to each divided tile S430. It is preferable to insert a watermark into a predetermined position. The insertion position may be changed by the setting of the user.

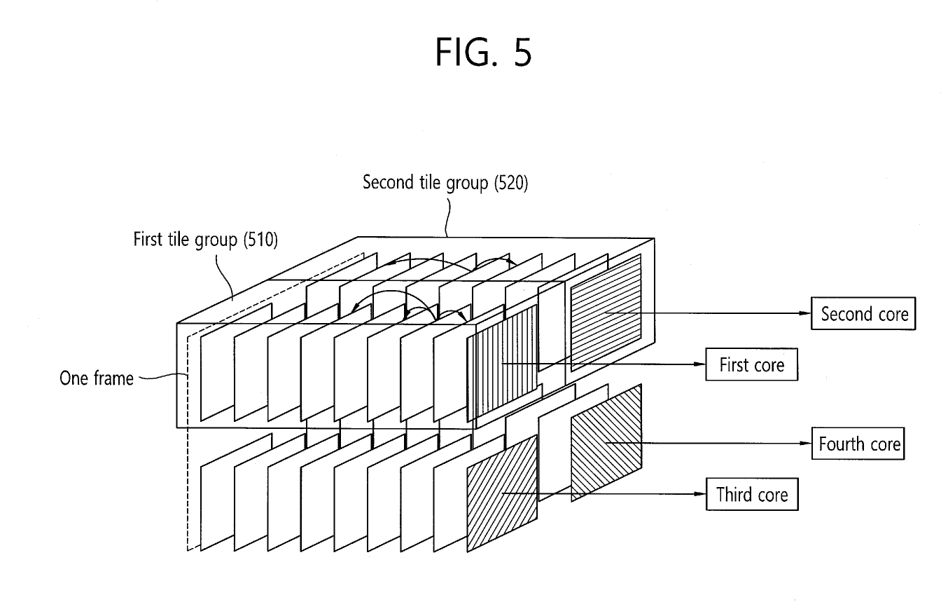

FIG. 5 illustrates an encoding concept in which video frames input continuously over time are divided into a plurality of tile groups and encoded separately.

Referring to FIG. 5, a plurality of video frames are input to the watermark embedding apparatus along the time axis. At this time, at least part of the plurality of input video frames are divided into tiles. The divided tiles are classified into tile groups according to their temporal correlation and are fed to the respective processors (cores). A first tile of a first frame (t1, 1) belongs to a first tile group, and a first tile of a second frame also belongs to the first tile group 510. At this time, each tile may be indexed by a frame number which represents a temporal order of the tile and the tile index in the corresponding frame. t(x, y) is a functional form of indexing a tile. x represents a frame number, and y represents the index of a tile in a specific frame. y may be used as an identifier of a tile group. In other words, in the first frame and the second to the n-th frame, the first tile belongs to the first tile group and is provided to the same core (first core), and encoding and watermark embedding may be performed in the corresponding core. At this time, the second tile (t1, 2) of the first frame and the second tile (t2, 2) of the second frame may belong to the second tile group 520. Those tiles belonging to the second tile group are provided to the second core, where encoding and watermark embedding may be performed. Typically, a tile divided into n×m tiles (in the embodiment of FIG. 5, a tile is divided into 2×2 tiles) is encoded independently from each other. At this time, regarding the reference relationship, it is preferable to limit a motion vector to reference other tiles not only in the same frame but also in other frames. Typically, in the HEVC standard, a motion vector is encoded as if there are no other tiles in the same frame to maintain independence of tiles; however, an inter-vector is allowed to use the whole region of other frame. In this regard, when a watermark embedding apparatus according to one embodiment of the present invention operates as a transcoder, encoded tile video data generated according to the HEVC standard is transcoded, after which a watermark may be embedded. At this time, the watermark embedding apparatus decodes tile data encoded in association with a specific tile. Then it is preferable for the watermark embedding apparatus to extract an encoded part by referencing other tile group of a different frame, modify and encode the referenced part of other tile group with respect to the extracted part, and reference the same referenced data as the motion vector of the same tile group, but if it is regarded as being still difficult to do so, it is preferable to remove the referenced part completely and perform re-encoding. And then, a task of embedding a watermark to each tile may be performed with respect to the tile data encoded in a completely independent form.

According to another embodiment of the present invention, tiles in a tile group are provided to and encoded by the core corresponding to the tile group. The data encoded in units of tiles by each core is provided to a single module where watermark embedding may be performed by batch processing. In other words, embedding of a watermark may be performed in parallel by a plurality of processors or by one processor in a sequential manner.

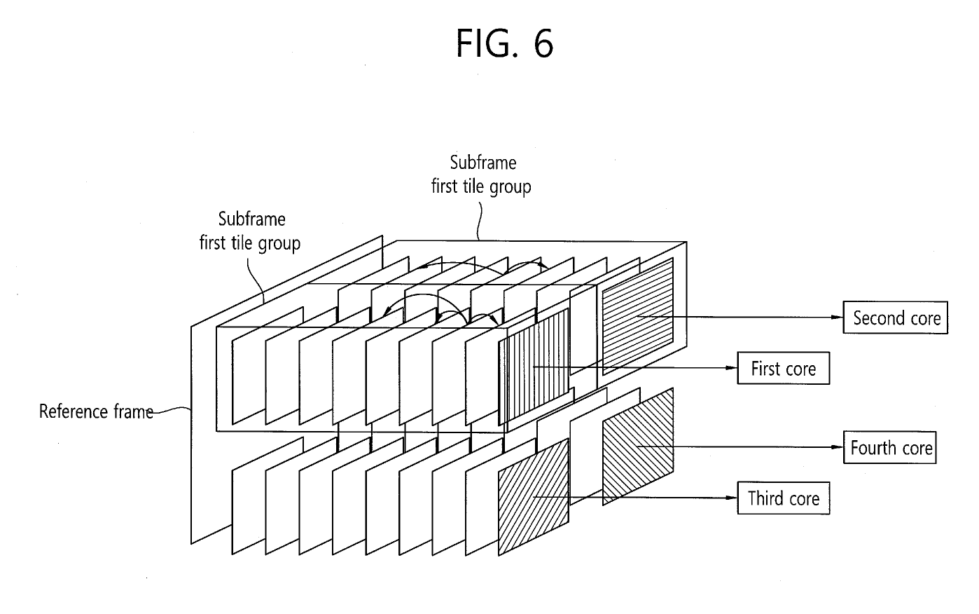

FIG. 6 illustrates a method for performing encoding of one reference frame and subframes according to another embodiment of the present invention.

Referring to FIG. 6, a watermark embedding apparatus may limit other tile group to reference tiles of a different frame and make tiles completely independent from each other, thereby preventing problems when tiles are replaced at the time of watermark embedding. At this time, a frame which has no reference relationship with a previous frame, such as a scene cut frame, may be set as the I frame (Intra frame) or P frame (Predictive-coded frame) in one specific segment, where the frame may be processed in a form of inserting index data instead of being processed as a completely independent tile. Here, the I frame may refer to a frame decoded through intra-prediction without referencing other frames, the P frame may refer to a frame referencing a uni-directional picture, and the B frame (Bidirectional-coded picture) may refer to a frame referencing a bidirectional picture.

The scene cut frame may become a reference frame. A frame preceding or succeeding the scene cut frame may be set as a subframe. A subframe may be divided into tile into which data of 0 to n−1 may be inserted. The scene cut frame may be used as a reference frame, which is used to control data related to encoding of the scene cut frame to be shared among the cores processing tiles.

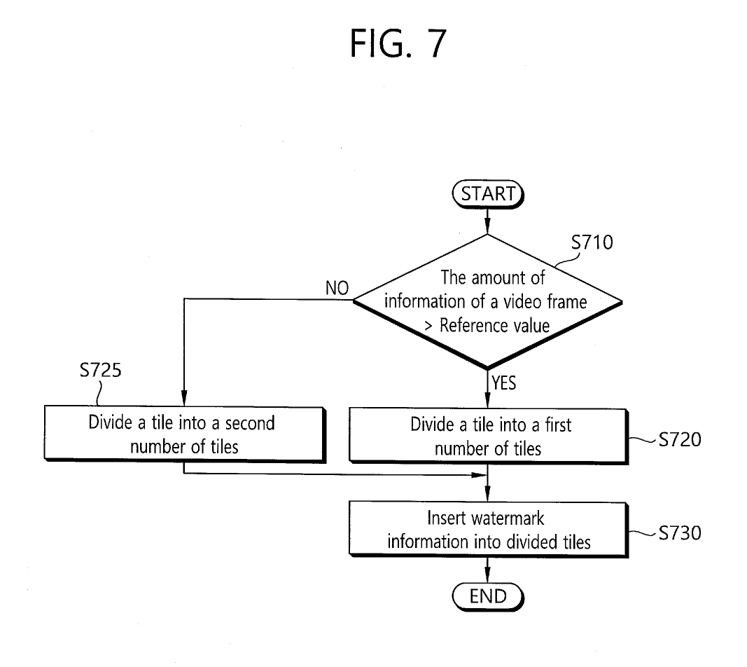

FIG. 7 is a flow diagram illustrating a watermark embedding method which embeds watermarks for video frames having different amounts of information according to one embodiment of the present invention.

Referring to FIG. 7, a watermark embedding apparatus may determine the size of watermark information to be inserted into each tile on the basis of the amount of information of an input video frame. To this purpose, the watermark embedding apparatus compares the amount of information of a video frame with a reference amount of information S710. When the amount of information of a video frame is larger than the reference amount, a tile is divided into a first number of tiles S720. When it is less than the reference amount, a tile may be divided into a second number of tiles S725. The first number may represent a number larger than the second number. And watermark information is inserted into as many tiles as the number of divisions S730. In other words, as the amount of information increases, it is preferable to insert watermark information composed of a large number of bits by dividing a video frame into a plurality of tiles.

At this time, the amount of information of an embedded watermark does not necessarily correspond to the amount of information of an input video frame but may be related to the type of the input video frame. In other words, in the case of a B frame which does not hold much information, a watermark of a relatively small number of bits is inserted while, in the case of an I frame or a P frame which holds a large amount of information, it is possible to increase a detection rate by inserting a watermark of a large number of bits. At this time, CBFM may also be employed in a similar manner.

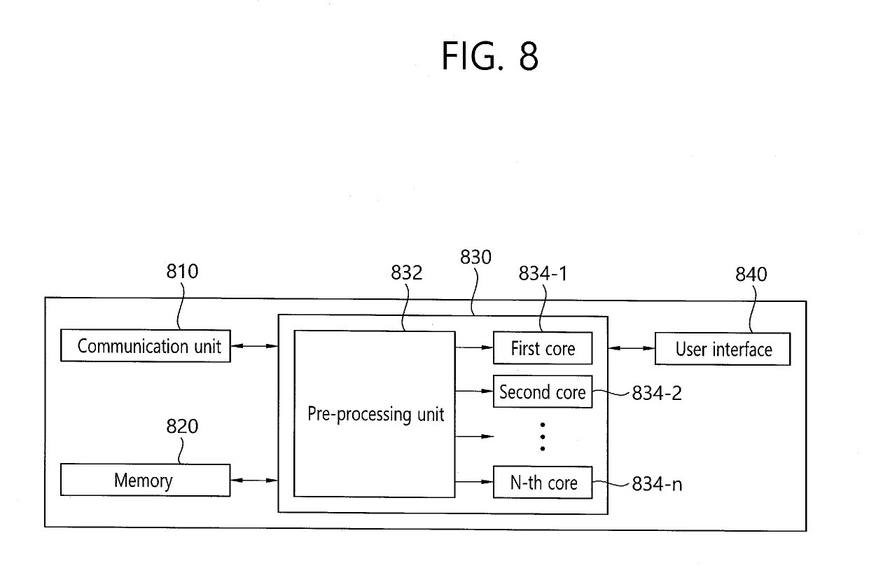

FIG. 8 illustrates a watermark embedding apparatus according to one embodiment of the present invention. As shown in FIG. 8, a watermark embedding apparatus according to one embodiment of the present invention may include a communication unit 810, memory 820, controller 830, and user interface 840.

Referring to FIG. 8, the communication unit 810 is responsible for communication with other device. The communication unit 810 may perform communication with other device by using a wired network and/or wireless network. It is also possible to perform communication by using a device of other type. The communication unit 810 may be implemented as an antenna and/or a communication processor. The communication unit 810 may receive a video frame to which a watermark is embedded and may transmit a bit stream embedded with a watermark to other device.

The memory 820 may store commands related to the functions performed in the controller 830. Also, the memory 820 may store a target video data and/or a bit stream for which watermark embedding has been completed. Moreover, the memory may store data related to the respective functions.

The communication unit 810 and the memory 820 performs the function of inputting video data to be processed by the controller 830 by taking into account an input of video data obtained from other device to the controller 830 or an input of pre-stored video data to the controller 830, which may be called an input unit.

The controller 830 may include a processor which performs encoding and watermark embedding. The controller 830 may include a pre-processing unit 832 which performs pre-processing for encoding and cores 834-1, . . . , 834-n.

The pre-processing unit 832 performs pre-processing for watermark embedding. The pre-processing unit 832 performs preparation for tile division and performs tile division. The pre-processing unit 832 may determine size of a tile and an encoding mode of a tile. Then the pre-processing unit 832 partitions a video frame to generate tiles. Divided tiles are provided to the cores 834-1, . . . , 834-n. At this time, if an input video frame is an already encoded video frame, the pre-processing unit 832 decodes the input video frame and determines whether a reference relationship exists with a tile belonging to other tile group. Then the pre-processing unit 830 extracts a portion having a reference relationship, deletes the corresponding data, and allocates the input video frame to cores 834-1, . . . , 834-n so that re-encoding may be performed.

The cores 834-1, . . . , 834-n perform encoding of tiles independently and in parallel. At this time, it is preferable for the cores 834-1, . . . , 834-n to perform encoding by excluding the reference relationship to other tile group as much as possible. And the cores 834-1, . . . , 834-n may insert a watermark to each tile of encoded data. An inserted watermark includes at least one bit of information or more. Depending on the situation, data for which encoding of each tile has been completed through a plurality of cores 834-1, . . . , 834-n may be provided to one processor, after which the processor may insert watermark information to each tile.

The user interface 840 includes an input device receiving a user input and/or an input/output device outputting data. The user interface 840 may include an input device such as a mouse, keyboard, and touchpad; and an output device such as a monitor, TV, and touch screen. The user may modify various configuration information of the watermark embedding apparatus and play encoded data by using the user interface 840.

Although the present invention has been described with reference to appended drawings and embodiments, the technical scope of the present invention is not limited by what is claimed by the drawings or embodiments. And it should be understood by those skilled in the art that various modifications and variations of the present invention may be made without departing from the technical principles and scope specified by the appended claims below.

What is claimed is:

1. A watermark embedding method in a watermark embedding apparatus, comprising:
inputting a video frame;
generating at least two tiles by spatially dividing the video frame; and
embedding watermark information to each of the at least two tiles.

2. The method of claim 1, wherein the inserting watermark information to each of the at least two tiles comprises embedding different watermark information to each of the at least two tiles.

3. The method of claim 1, wherein each of the at least two files is encoded independently and does not form a reference relationship with the other tile.

4. The method of claim 3, wherein the inputting a video frame comprises inputting a plurality of video frames continuously in time,
at least a part of the plurality of input video frames is divided into at least two tiles, and
each tile divided from a video frame belongs to one of a first and a second tile group.

5. The method of claim 4, wherein a tile belonging to the first tile group in a first video frame is encoded to form a reference relationship with a tile belonging to the first tile group before or after the first video frame but not to form a reference relationship with a tile belonging to the second tile group.

6. The method of claim 4, wherein a video stream associated with a tile belonging to the first tile group and a video stream associated with a tile belonging to the second tile group are processed in parallel by using different processors.

7. The method of claim 4, when the video frame is a pre-encoded video stream, comprising
decoding the pre-encoding video stream;
extracting a portion having a reference relationship with other tile groups from the decoded video stream;
removing a reference relationship of the extracted portion; and
re-encoding the extracted portion in a tile-independent manner by removing a reference relationship with tiles of the other tile group.

8. The method of claim 1, wherein a scene cut frame which does not reference a previous video frame is not divided into tiles but is referenced commonly by different tiles of a video frame referencing the scene cut frame.

9. The method of claim 1, wherein, when the video frame is a B frame, watermark information composed of a smaller number of bits than a reference value is embedded while, when the video frame is an I frame, watermark information composed of a larger number of bits than a reference value is embedded.

10. The method of claim 1, wherein, when the amount of information of the video frame is less than a first reference value, watermark information composed of a smaller number of bits than a second reference value is embedded while, when the amount of information of the video frame is larger than the first reference value, watermark information composed of a larger number of bits than the second reference value is embedded.

11. The method of claim 1, wherein the at least two tiles are tiles associated with the HEVC (High Efficiency Video Coding) standard.

12. The method of claim 1, further comprising, in dividing the at least two tiles, determining a tile size and a tile structure by estimating at least one of complexity and decoding time for each tile.

13. The method of claim 12, wherein, in dividing the at least two tiles, tile division is performed in a direction of allocating an equal amount of task for processors corresponding to the respective tiles by taking into account at least one of complexity and decoding time for each tile.

14. A watermark embedding apparatus, comprising:
an input unit inputting a video frame; and
a controller generating at least two tiles by spatially dividing the video frame and embedding watermark information to each of the at least two tiles.

15. The apparatus of claim 14, wherein the controller comprises at least two processors,
wherein each of the at least two tiles are processed in parallel by the corresponding one of the at least two processors.
